(19) United States
(12) Patent Application Publication
(10) Pub. No.: US 2015/0329382 A1
(43) Pub. Date: Nov. 19, 2015

(54) Electrocoagulation Removal of Zinc in Produced Water

(71) Applicant: Halliburton Energy Services, Inc., Houston, TX (US)

(72) Inventors: Paul David Lord, Cypress, TX (US); Jimmie D. Weaver, Duncan, OK (US); Daniel Edward Shannon, Houston, TX (US)

(73) Assignee: Halliburton Energy Services, Inc., Houston, TX (US)

(21) Appl. No.: 14/278,978

(22) Filed: May 15, 2014

(51) Int. Cl. C02F 1/463

(52) U.S. Cl. CPC C02F 1/463; C02F 2101/32

(57) ABSTRACT

Electrocoagulation may be used to reduce the concentration of zinc ions in produced water. For example, a method may induce producing a wellbore fluid from a subterranean formation, the wellbore fluid comprising hydrocarbons and water, the water having zinc ions dispersed therein at a concentration greater than about 1 ppm; separating the hydrocarbons from the water; and separating at least some of the zinc ions from the water via electrocoagulation to yield an effluent water and precipitated zinc salts.

### BACKGROUND

The embodiments described herein relate to reduction of zinc concentrations in produced water.

Zinc salts (e.g., zinc bromide) may be used in drilling fluids stimulation fluids to increases the density or weight of the fluid. The weight of the fluid counters the pressures in the formation and stabilize the wellbore and surrounding subterranean formation, thereby mitigating wellbore collapse and undesirable invasion of formation fluids into the wellbore. In some instances, the zinc salts may become incorporated in formation water. During production operations, formation water and water from drilling fluids and stimulation fluids may be produced with hydrocarbons.

At the well site, the produced water may be separated from the produced hydrocarbons. Depending on the purity, the produced water may be released to the local environment (e.g., discarded overboard for an offshore rig). However, in some instances, the concentration of zinc may be sufficiently high that this is not an option.

In some instances, chemical coagulants may be used to consolidate contaminants (e.g., the organic materials) from produced water into a form that can be removed by hydrocyclones. However, these methods do not effectively remove ions like zinc.

Other methods for reducing zinc ion concentrations may include adding other salts to precipitate zinc salts, which is driven by the thermodynamics. However, halide ion concentrations are often high in produced waters because chloride and bromide salts are often used in drilling and production fluids, which as described above become incorporated in the produced water. These high halide ion concentrations may make this thermodynamic precipitation scheme inefficient and expensive by requiring excessive amounts of salts to precipitate the zinc.

As environmental regulations expand, a need exists for effective removal of ions like zinc from produced waters.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 provides an illustration of a system according to at least some embodiments described herein.

FIG. 2 provides an illustration of an electrocoagulation system or portion thereof according to at least some embodiments described herein.

FIG. 3 provides an illustration of an electrocoagulation system 320 according to at least some embodiments described herein.

### DETAILED DESCRIPTION

The embodiments described herein relate to reduction of zinc concentrations in produced water.

Electrocoagulation systems and methods are described herein for reducing the concentration of zinc ions in produced water. Generally, electrocoagulation systems use electrochemical processes to precipitate zinc salts from the produced water. Such electrocoagulation systems and methods may advantageously be effective when treating produced water with high concentrations of halide ions.

Additionally, the electrocoagulation systems may be modular where several housings or units may be placed in series, parallel, or both to provide for greater removal capacity as needed for higher concentrations of zinc ions, higher concentrations of halide ions, or both.

In some instances, the electrocoagulation systems described herein may be compact with a footprint, which may be advantageous for use at offshore well sites where space is often a limiting factor to implementation of a technology.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques. Further, it should be noted that when “about” is provided herein at the beginning of a numerical list, “about” modifies each number of the numerical list. It should be noted that in some numerical listings of ranges, some lower limits listed may be greater than some upper limits listed. One skilled in the art will recognize that the selected subset will require the selection of an upper limit in excess of the selected lower limit.

In some embodiments, systems described herein may include a wellbore penetrating a subterranean formation with a tubular disposed in the wellbore. The tubular may contain a fluid comprising petroleum hydrocarbons and water, the water having zinc ions and, in some instances, halide ions dispersed therein. The system further includes an electrocoagulation system in fluid communication with the tubular and being capable of receiving the fluid from the tubular. As used herein, the terms “fluid communication,” “fluidly communicable,” and the like refer to two or more components, systems, etc. being coupled such that fluid from one may flow to the other. In some embodiments, other components, systems, etc. may be disposed between the two or more components that are fluidly communicable. For example, valves, flow meters, pumps, mixing tanks, holding tanks, tubulars, separation systems, and the like may be disposed between two or more components that are fluidly communicable.

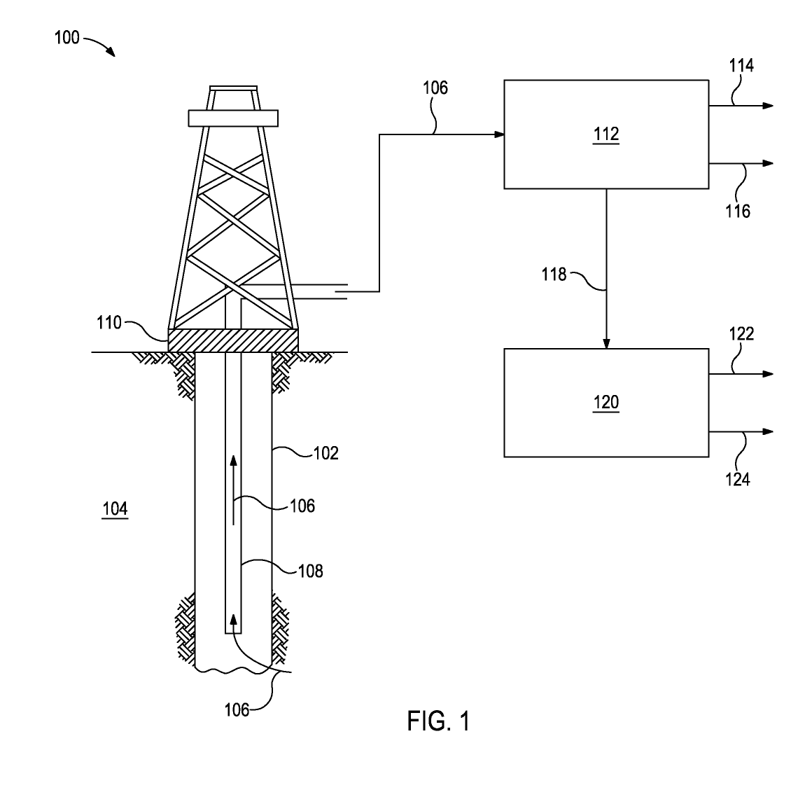

FIG. 1 provides an illustration of a system 100 according to at least some embodiments described herein. It should be noted that while FIG. 1 generally depicts a land-based system, it is to be recognized that like systems may be operated in subsea locations as well. As depicted in FIG. 1, system 100 may include a wellbore 102 penetrating a subterranean formation 104. A wellbore fluid 106 produced from the subterranean formation 104 may travel up a tubular 108 disposed in the wellbore 102. Generally, the wellbore fluid 106 may include hydrocarbons (e.g., oil and gas) and water. The water may have zinc ions dispersed therein.

After the wellbore fluids 106 reach the wellhead 110, the wellbore fluids 106 may be treated in a separator 112 (e.g., a three-phase separator) for separating the hydrocarbons (e.g., oil 116 and gas 114) from the water 118. The water 118 may then be treated in an electrocoagulation system 120 to produce effluent water 122 and precipitated salts 124.

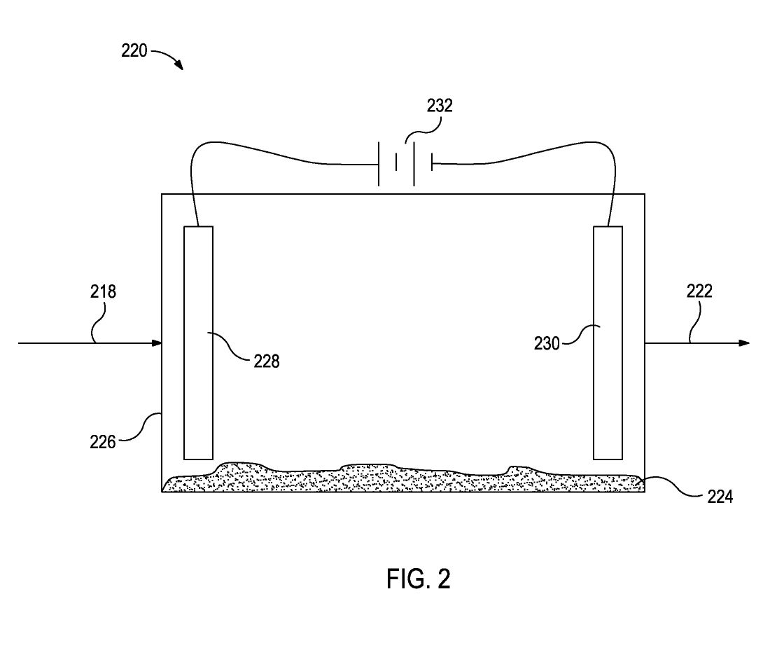

FIG. 2 provides an illustration of an electrocoagulation system 220 or portion thereof according to at least some embodiments described herein. The electrocoagulation system receives and contains the water 218 in a housing 226. Also contained within the housing 226 is an anode 228 and a cathode 230, which are electrically coupled via a power source 232 (e.g., a DC power source). During operation, the zinc ions precipitate as salts 224. The resultant effluent water 222 may then be utilized, discarded, or further treated as described herein.

In some embodiments, a device (not shown) for regulating a current density between the pairs of electrodes may be included in the electrocoagulation system 220. In some embodiments, the power and current density used during operation may depend on, inter alia, the concentration of ions in the water, the degree to which zinc is removed from the water, and the like. For example, higher power and current density may precipitate higher concentrations of zinc ions as salts. In some instances, the power may range from about 300 volts to about 600 volts, including any subset therebetween. In some instances, the current density may range from about 100 amps to about 300 amps, including any subset therebetween. In some instances, the power and current density may be outside these ranges.

In some embodiments, the power, current density, or both may be adjusted during electrocoagulation. For example, if the concentration of ions (e.g., zinc ions, halide ions, or both) increases in the water, the power, current density, or both may be increased to enhance removal of the ions.

Anodes and cathodes may be made of any suitable materials for conducting an electrochemical process described herein. Exemplary materials may include stainless steel, copper, iron, aluminum, graphite, and the like, and any combination thereof. One skilled in the art would recognize that the material for the anode and cathode should be chosen to provide for oxidation of the anode and reduction of the cathode.

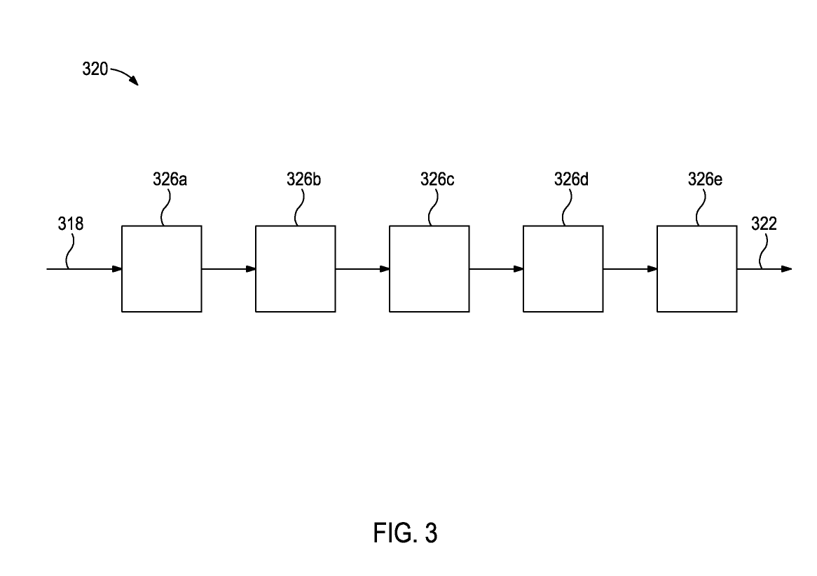

In some embodiments, electrocoagulation systems may include several housings in series, each with anodes and cathodes as describe above. For example, FIG. 3 provides an illustration of an electrocoagulation system 320 according to at least some embodiments described herein. The electrocoagulation system 320 includes five housings 326a-e in series each including cathodes and anodes (not shown). One skilled in the art with the benefit of this disclosure would recognize the plurality of configurations for electrocoagulation systems including having housings in series, parallel, or both.

In some embodiments, the resulting effluent water 322 may be retreated in the electrocoagulation system 320 (e.g., combined with the water 318) to further reduce the concentration of zinc ions. In some embodiments, the electrocoagulation system 320 may include a sensor (not shown) for detecting the concentration of zinc ions in the effluent water 322. Exemplary sensors may include Zn²⁺-selective potentiometric sensor; titrators in combination with colorimetric sensors, potentiometric sensors, or both; an atomic absorption spectrometer; and inductively coupled plasmas in combination with an atomic emission spectrometer, a mass spectrometers, or both.

In some embodiments, such sensors may be downstream of the electrocoagulation system 320. In some embodiments, such sensor may also be located between individual housings 326a-e. In some embodiments, such sensors may be located upstream of the electrocoagulation system 320. Locating sensors in a combination of the foregoing may allow for monitoring the removal of the zinc ions by comparing the concentration of zinc ions at various points along the electrocoagulation system 320.

One of skill in the art will recognize appropriate threshold values for the concentration of zinc ions useful in determining if the effluent water 322 should be retreated in the electrocoagulation system 320, which may be based on environmental regulations, company policies, and the like. By way of nonlimiting example, effluent water 322 having a concentration of zinc ions greater than about 1 ppm may be retreated in the electrocoagulation system 320.

In some embodiments, the concentration of zinc ions in the water before electrocoagulation may be at about 1 ppm or greater (about 10 ppm or greater, or about 50 ppm or greater). In some embodiments, the concentration of zinc ions in the water before electrocoagulation may be range from a lower limit of about 1 ppm, 10 ppm, or 50 ppm to an upper limit of about 500 ppm, 250 ppm, or 100 ppm, wherein the concentration of zinc ions in the water may be between any lower limit and any upper limit and encompass any subset therebetween.

In some embodiments, the concentration of zinc ions in the water may be reduced using electrocoagulation by about 90% or greater, about 95% or greater, about 98% or greater, or about 99% or greater (e.g., as determined by comparing the concentration of zinc ions in the water before entering the electrocoagulation system and the effluent water from the electrocoagulation system).

In some embodiments, the concentration of zinc ions in the effluent water may be range from a lower limit of about 0.001 ppm, 0.01 ppm, or 0.1 ppm to an upper limit of about 1 ppm, 0.5 ppm, or 0.1 ppm, wherein the concentration of zinc ions in the effluent water may be between any lower limit and any upper limit and encompass any subset therebetween.

In some embodiments, the pH of the water may be adjusted during or before electrocoagulation to facilitate precipitation of zinc salts. In some instances, the pH of the water during or before electrocoagulation may be at or adjusted to a pH ranging from a lower limit of about 3, 4, 5, 6, 7, or 8 to an upper limit of about 12, 11, 10, 9, or 8, wherein the pH may be between any lower limit and any upper limit and encompass any subset therebetween.

In some embodiments, acids, bases, or buffers may be used to adjust or maintain a desired pH level. With reference to FIG. 3, in some instances, the pH of the water in individual housings 326a-e may be different. For example, the pH in system 300 may increase progressively from housing to housing to remove zinc ions. For example, a component for adding acid, base, or buffer to the water may be located between individual housings 326a-e, so as to adjust the pH of the water before each electrocoagulation treatment. In some instances, pH meters may be located between or at individual housings 326a-e to monitor the pH of the water along the system 300.

As described above, electrocoagulation systems and methods may advantageously be effective when treating water with high concentrations of halide ions. In some embodiments, the concentration of halide ions in the produced water before electrocoagulation may be greater than about 10,000 ppm, greater than about 50,000 ppm, or greater than about 100,000 ppm. In some embodiments, the concentration of halide ions in the produced water before electrocoagulation may be range from a lower limit of about 10,000 ppm, 50,000 ppm, or 100,000 ppm to an upper limit of about 250,000 ppm, 200,000 ppm 150,000 ppm or 100,000 ppm, wherein the concentration of halide ions in the produced water may be between any lower limit and any upper limit and encompass any subset therebetween.

In some embodiments, the resulting effluent water may be collected, released, used in a wellbore operation, or a combination thereof. Exemplary wellbore operations may include drilling operations, stimulation operations (e.g., fracking, acid stimulation, steam operations), cementing operations, and production operations. Some embodiments may involve introducing the effluent water into the wellbore (e.g., as part of a drilling or treatment fluid).

Embodiments disclosed herein include Embodiment A, Embodiment B, and Embodiment C.

Embodiment A: A method that induces producing a wellbore fluid from a subterranean formation, the wellbore fluid comprising hydrocarbons and water, the water having zinc ions dispersed therein at a concentration greater than about 1 ppm; separating the hydrocarbons from the water; and separating at least some of the zinc ions from the water via electrocoagulation to yield an effluent water and precipitated zinc salts.

Embodiment A may have one or more of the following additional elements in any combination: Element A1: wherein a concentration of the zinc ions in the effluent water has been reduced by about 90% or more as compared to the water before electrocoagulation; Element A2: wherein a concentration of the zinc ions in the effluent water is about 0.001 ppm to about 1 ppm; Element A3: wherein a concentration of the zinc ions in the water before electrocoagulation is about 50 ppm or greater; Element A4: wherein the water has a concentration of halide ions greater than about 10,000 ppm; Element A5: wherein the water has a concentration of halide ions greater than about 100,000 ppm; Element A6: the method further including adjusting the pH of the water before or during the electrocoagulation to between about 3 and about 12; Element A7: the method further including introducing the effluent water into a wellbore penetrating the subterranean formation; Element A8: the method further including disposing of the effluent water; and Element A9: the method further including retreating the effluent water via the electrocoagulation.

By way of non-limiting example, exemplary combinations applicable to Embodiment A include: combinations of Elements A1 and A2 optionally in combination with Element A4 or A5; combinations of Elements A1 and A3 optionally in combination with Element A4 or A5; combinations of Elements A2 and A3 optionally in combination with Element A4 or A5; combinations of Elements A3 and A6; combinations of Elements A1 and A6; combinations of Elements A2 and A6; combinations of Elements A1, A3, and A6 optionally in combination with Element A4 or A5; and Elements A2, A3, and A6 optionally in combination with Element A4 or A5.

Embodiment B: A method that induces producing a wellbore fluid from a subterranean formation, the wellbore fluid comprising hydrocarbons and water, the water having zinc ions dispersed therein; separating the hydrocarbons from the water; separating at least some of the zinc ions from the water via a first electrocoagulation to yield an effluent water and precipitated zinc salts, wherein the effluent water has a concentration of the zinc ions of greater than about 1 ppm; and retreating the effluent water via a second electrocoagulation.

Embodiment B may have one or more of the following additional elements in any combination: Element B1: wherein a concentration of the zinc salts in the effluent water has been reduced by about 90% or more as compared to the water before electrocoagulation; Element B2: wherein the water has a concentration of halide ions greater than about 10,000 ppm; Element B3: wherein the water has a concentration of halide ions greater than about 100,000 ppm; Element B4: the method further including adjusting the pH of the water before or during the first electrocoagulation to between about 3 and about 12; Element B5: the method further including adjusting the pH of the water before or during the second electrocoagulation to between about 3 and about 12; Element B6: the method further including introducing the water after the second electrocoagulation into a wellbore penetrating the subterranean formation; Element B7: the method further including disposing of the water after the second electrocoagulation; and Element B8: the method further including retreating the water after the second electrocoagulation via a third electrocoagulation.

By way of non-limiting example, exemplary combinations applicable to Embodiment B include: combinations of Elements B1 and B2 optionally in combination with Element B4, B5, or both; Elements B1 and B3 optionally in combination with Element B4, B5, or both; and one or more of Elements B6, B7, or B8 in combination with the foregoing.

Embodiment C: A system that induces a wellbore penetrating a subterranean formation; a tubular disposed in the wellbore containing a wellbore fluid comprising hydrocarbons and water, the water having zinc ions dispersed therein at a concentration greater than about 1 ppm; and an electrocoagulation system in fluid communication with the tubular and being capable of receiving the wellbore fluid from the tubular.

Embodiment C may have one or more of the following additional elements in any combination: Element C1: wherein the electrocoagulation system comprises a sensor for measuring a concentration of the zinc ions in the water; Element C2: wherein a concentration of the zinc ions in the water is about 50 ppm or greater; and Element C3: wherein the water has a concentration of halide ions greater than about 10,000 ppm.

By way of non-limiting example, exemplary combinations applicable to Embodiment C include: combinations of Elements C1 and C2; combinations of Elements C2 and C3; combinations of Elements C1 and C3; and combinations of Elements C1, C2, and C3.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### EXAMPLES

### Example 1

A sample of produced water was treated via electrocoagulation at pH 6.2. The concentration of various metal ions were analyzed before and after electrocoagulation, see Table 1.

TABLE 1

| | Conc. Before | Conc. After |
|---|---|---|
| | Electrocoagulation | Electrocoagulation |
| Ion | (ppm) | (ppm) |
| aluminum | 0.37 | 0.25 |
| boron | 11.8 | 9.35 |
| barium | 0.08 | 1.17 |
| calcium | 3901 | 3252 |
| chlorine | 99,515 | 100,132 |
| iron | 1.23 | 20.8 |
| potassium | 522 | 430 |
| magnesium | 886 | 695 |
| sodium | 66,132 | 53,826 |
| sulfate | 4000 | 3400 |
| strontium | 83.4 | 69.8 |
| zinc | 104 | 6.2 |

This example demonstrates that electrocoagulation may be effective at removing zinc ions and other ions from a water supply, even in the presence of high concentrations of halide.

### Example 2

A sample of produced water was treated via electrocoagulation at pH 6.2 and pH 9.2. The concentration of zinc ions were analyzed before electrocoagulation was about 104 ppm. After electrocoagulation treatment, the sample at pH 6.2 had about 6.2 ppm of zinc ions, and the sample at pH 9.2 had about 0.08 ppm of zinc ions. This example demonstrates that adjusting the pH of the fluid before electrocoagulation may be useful for increasing the efficacy of electrocoagulation in removing zinc ions from a water supply.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

1. A method comprising:
producing a wellbore fluid from a subterranean formation, the wellbore fluid comprising hydrocarbons and water, the water having zinc ions dispersed therein at a concentration greater than about 1 ppm;
separating the hydrocarbons from the water; and
separating at least some of the zinc ions from the water via electrocoagulation to yield an effluent water and precipitated zinc salts.

2. The method of claim 1, wherein a concentration of the zinc ions in the effluent water has been reduced by about 90% or more as compared to the water before electrocoagulation.

3. The method of claim 1, wherein a concentration of the zinc ions in the effluent water is about 0.001 ppm to about 1 ppm.

4. The method of claim 1, wherein a concentration of the zinc ions in the water before electrocoagulation is about 50 ppm or greater.

5. The method of claim 1, wherein the water has a concentration of halide ions greater than about 10,000 ppm.

6. The method of claim 1, wherein the water has a concentration of halide ions greater than about 100,000 ppm.

7. The method of claim 1 further comprising:
adjusting the pH of the water before or during the electrocoagulation to between about 3 and about 12.

8. The method of claim 1 further comprising:
introducing the effluent water into a wellbore penetrating the subterranean formation.

9. The method of claim 1 further comprising:
disposing of the effluent water.

10. The method of claim 1 further comprising:
retreating the effluent water via the electrocoagulation.

11. A method comprising:
producing a wellbore fluid from a subterranean formation, the wellbore fluid comprising hydrocarbons and water, the water having zinc ions dispersed therein;
separating the hydrocarbons from the water;
separating at least some of the zinc ions from the water via a first electrocoagulation to yield an effluent water and precipitated zinc salts, wherein the effluent water has a concentration of the zinc ions of greater than about 1 ppm; and
retreating the effluent water via a second electrocoagulation.

12. The method of claim 11, wherein a concentration of the zinc salts in the effluent water has been reduced by about 90% or more as compared to the water before electrocoagulation.

13. The method of claim 11, wherein the water has a concentration of halide ions greater than about 10,000 ppm.

14. The method of claim 11 further comprising:
adjusting the pH of the water before or during the first electrocoagulation to between about 3 and about 12.

15. The method of claim 11 further comprising:
adjusting the pH of the water before or during the second electrocoagulation to between about 3 and about 12.

16.-19. (canceled)
